(19) United States
(12) Patent Application Publication
(10) Pub. No.: US 2017/0177563 A1
(43) Pub. Date: Jun. 22, 2017

(54) METHODS AND SYSTEMS FOR AUTOMATED TEXT CORRECTION

(71) Applicant: National University of Singapore, Singapore (SG)

(72) Inventors: Daniel Hermann Richard Dahlmeier, Singapore (SG); Hwee Tou Ng, Singapore (SG)

(73) Assignee: National University of Singapore, Singapore (SG)

(21) Appl. No.: 15/451,387

(22) Filed: Mar. 6, 2017

Related U.S. Application Data
(62) Division of application No. 13/878,983, filed on Apr. 11, 2013.
(60) Provisional application No. 61/509,151, filed on Jul. 19, 2011.
(60) Provisional application No. 61/495,902, filed on Jun. 10, 2011.
(60) Provisional application No. 61/386,183, filed on Sep. 24, 2010.

(51) Int. Cl. G06F 17/27; G06F 17/24

(52) U.S. Cl. CPC G06F 17/276; G06F 17/274; G06F 17/241

(57) ABSTRACT

The present embodiments demonstrate systems and methods for automated text correction. In certain embodiments, the methods and systems may be implemented through analysis according to a single text correction model. In a particular embodiment, the single text correction model may be generated through analysis of both a corpus of learner text and a corpus of non-learner text.

### CROSS-REFERENCE TO RELATED APPLICATIONS

This application is a divisional of U.S. patent application Ser. No. 13/878,983 filed Apr. 11, 2013 which is a national phase application under 35 U.S.C. §371 of International Application No. PCT/SG2011/000331 filed Sep. 23, 2011, which claims priority to U.S. Provisional Application No. 61/386,183 filed Sep. 24, 2010, U.S. Provisional Application No. 61/495,902 filed Jun. 10, 2011, and U.S. Provisional Application No. 61/509,151 filed Jul. 19, 2011, all of which are incorporated herein by reference in their entirety.

### BACKGROUND

Field of the Invention

This invention relates to methods and systems for automated text correction.

Description of the Related Art

Text correction is often difficult and time consuming. Additionally, it is often expensive to edit text, particularly involving translations, because editing often requires the use of skilled and trained workers. For example, editing of a translation may require intensive labor to be provided by a worker with a high level of proficiency in two or more languages.

Automated translation systems, such as certain online translators, may alleviate some of the labor intensive aspects of translation, but they are still not capable of replacing a human translator. In particular, automated systems do a relatively good job of word to word translation, but the meaning of a sentence is often lost because of inaccuracies in grammar and punctuation.

Certain automated text editing systems do exist, but such systems generally suffer from inaccuracy. Additionally, prior automated text editing systems may require a relatively large amount of processing resources.

Some automated text editing systems may require training or configuration to edit text accurately. For example, certain prior systems may be trained using an annotated corpus of learner text. Alternatively, some prior art systems may be trained using a corpus of non-learner text that is not annotated. One of ordinary skill in the art will recognize the differences between learner text and non-learner text.

Outputs of standard automatic speech recognition (ASR) systems typically consist of utterances where important linguistic and structural information, such as true case, sentence boundaries, and punctuation symbols, is not available. Linguistic and structural information improves the readability of the transcribed speech texts, and assists in further downstream processing, such as in part-of-speech (POS) tagging, parsing, information extraction, and machine translation.

Prior punctuation prediction techniques make use of both lexical and prosodic cues. However, prosodic features such as pitch and pause duration, are often unavailable without the original raw speech waveforms. In some scenarios where further natural language processing (NLP) tasks on the transcribed speech texts become the main concern, speech prosody information may not be readily available. For example, in the evaluation campaign of the International Workshop on Spoken Language Translation (IWSLT), only manually transcribed or automatically recognized speech texts are provided but the original raw speech waveforms are not available.

Punctuation insertion conventionally is performed during speech recognition. In one example, prosodic features together with language model probabilities were used within a decision tree framework. In another example, insertion in the broadcast news domain included both finite state and multi-layer perceptron methods for the task, where prosodic and lexical information was incorporated. In a further example, a maximum entropy-based tagging approach to punctuation insertion in spontaneous English conversational speech, including the use of both lexical and prosodic features, was exploited. In yet another example, sentence boundary detection was performed by making use of conditional random fields (CRF). The boundary detection was shown to improve over a previous method based on the hidden Markov model (HMM).

Some prior techniques consider the sentence boundary detection and punctuation insertion task as a hidden event detection task. For example, a HMM may describe a joint distribution over words and inter-word events, where the observations are the words, and the word/event pairs are encoded as hidden states. Specifically, in this task word boundaries and punctuation symbols are encoded as inter-word events. The training phase involves training an n-gram language model over all observed words and events with smoothing techniques. The learned n-gram probability scores are then used as the HMM state-transition scores. During testing, the posterior probability of an event at each word is computed with dynamic programming using the forward-backward algorithm. The sequence of most probable states thus forms the output which gives the punctuated sentence. Such a HMM-based approach has several drawbacks.

First, the n-gram language model is only able to capture surrounding contextual information. However, modeling of longer range dependencies may be needed for punctuation insertion. For example, the method is unable to effectively capture the long range dependency between the initial phrase “would you” which strongly indicates a question sentence, and an ending question mark. Thus, special techniques may be used on top of using a hidden event language model in order to overcome long range dependencies.

Prior examples include relocating or duplicating punctuation symbols to different positions of a sentence such that they appear closer to the indicative words (e.g., “how much” indicates a question sentence). One such technique suggested duplicating the ending punctuation symbol to the beginning of each sentence before training the language model. Empirically, the technique has demonstrated its effectiveness in predicting question marks in English, since most of the indicative words for English question sentences appear at the beginning of a question. However, such a technique is specially designed and may not be widely applicable in general or to languages other than English. Furthermore, a direct application of such a method may fail in the event of multiple sentences per utterance without clearly annotated sentence boundaries within an utterance.

Another drawback associated with such an approach is that the method encodes strong dependency assumptions between the punctuation symbol to be inserted and its surrounding words. Thus, it lacks the robustness to handle cases where noisy or out-of-vocabulary (OOV) words frequently appear, such as in texts automatically recognized by ASR systems.

Grammatical error correction (GEC) has also been recognized as an interesting and commercially attractive problem in natural language processing (NLP), in particular for learners of English as a foreign or second language (EFL/ESL).

Despite the growing interest, research has been hindered by the lack of a large annotated corpus of learner text that is available for research purposes. As a result, the standard approach to GEC has been to train an off-the-shelf classifier to re-predict words in non-learner text. Learning GEC models directly from annotated learner corpora is not well explored, as are methods that combine learner and non-learner text. Furthermore, the evaluation of GEC has been problematic. Previous work has either evaluated on artificial test instances as a substitute for real learner errors or on proprietary data that is not available to other researchers. As a consequence, existing methods have not been compared on the same test set, leaving it unclear where the current state of the art really is.

The de facto standard approach to GEC is to build a statistical model that can choose the most likely correction from a confusion set of possible correction choices. The way the confusion set is defined depends on the type of error. Work in context-sensitive spelling error correction has traditionally focused on confusion sets with similar spelling (e.g., {dessert, desert}) or similar pronunciation (e.g., {there, their}). In other words, the words in a confusion set are deemed confusable because of orthographic or phonetic similarity. Other work in GEC has defined the confusion sets based on syntactic similarity, for example all English articles or the most frequent English prepositions form a confusion set.

### SUMMARY

The present embodiments demonstrate systems and methods for automated text correction. In certain embodiments, the methods and systems may be implemented through analysis according to a single text editing model. In a particular embodiment, the single text editing model may be generated through analysis of both a corpus of learner text and a corpus of non-learner text.

According to one embodiment, an apparatus includes at least one processor and a memory device coupled to the at least one processor, in which the at least one processor is configured to identify words of an input utterance. The at least one processor is also configured to place the words in a plurality of first nodes stored in the memory device. The at least one processor is further configured to assign a word-layer tag to each of the first nodes based, in part, on neighboring nodes of the linear chain. The at least one processor is also configured to generate an output sentence by combining words from the plurality of first nodes with punctuation marks selected, in part, on the word-layer tags assigned to each of the first nodes.

According to another embodiment, a computer program product includes a computer-readable medium having code to identify words of an input utterance. The medium also includes code to place the words in a plurality of first nodes stored in the memory device. The medium further includes code to assign a word-layer tag to each of the plurality of first nodes based, in part, on neighboring nodes of the plurality of first nodes. The medium also includes code to generate an output sentence by combining words from the plurality of first nodes with punctuation marks selected, in part, on the word-layer tags assigned to each of the first nodes.

According to yet another embodiment, a method includes identifying words of an input utterance. The method also includes placing the words in a plurality of first nodes. The method further includes assigning a word-layer tag to each of the first nodes in the plurality of first nodes based, in part, on neighboring nodes of the plurality of first nodes. The method yet also includes generating an output sentence by combining words from the plurality of first nodes with punctuation marks selected, in part, on the word-layer tags assigned to each of the first nodes.

Additional embodiments of a method include receiving a natural language text input, the text input comprising a grammatical error in which a portion of the input text comprises a class from a set of classes. This method may also include generating a plurality of selection tasks from a corpus of non-learner text that is assumed to be free of grammatical errors, wherein for each selection task a classifier re-predicts a class used in the non-learner text. Further, the method may include generating a plurality of correction tasks from a corpus of learner text, wherein for each correction task a classifier proposes a class used in the learner text. Additionally, the method may include training a grammar correction model using a set of binary classification problems that include the plurality of selection tasks and the plurality of correction tasks. This embodiment may also include using the trained grammar correction model to predict a class for the text input from the set of possible classes.

In a further embodiment, the method includes outputting a suggestion to change the class of the text input to the predicted class if the predicted class is different than the class in the text input. In such an embodiment, the learner text is annotated by a teacher with an assumed correct class. The class may be an article associated with a noun phrase in the input text. The method may also include extracting feature functions for the classifiers from noun phrases in the non-learner text and the learner text.

In another embodiment, the class is a preposition associated with a prepositional phrase in the input text. Such a method may include extracting feature functions for the classifiers from prepositional phrases in the non-learner text and the learner text.

In one embodiment, the non-learner text and the learner text have a different feature space, the feature space of the learner text including the word used by a writer. Training the grammar correction model may include minimizing a loss function on the training data. Training the grammar correction model may also include identifying a plurality of linear classifiers through analysis of the non-learner text. The linear classifiers further comprise a weight factor included in a matrix of weight factors.

In one embodiment, training the grammar correction model further comprises performing a Singular Value Decomposition (SVD) on the matrix of weight factors. Training the grammar correction model may also include identifying a combined weight value that represents a first weight value element identified through the analysis of the non-learner text and a second weight value component that is identified by analyzing a learner text by minimizing an empirical risk function.

An apparatus is also presented for automated text correction. The apparatus may include, for example, a processor configured to perform the steps of the methods described above.

Another embodiment of a method is presented. The method may include correcting semantic collocation errors. One embodiment of such a method includes automatically identifying one or more translation candidates in response to analysis of a corpus of parallel-language text conducted in a processing device. Additionally, the method may include determining, using the processing device, a feature associated with each translation candidate. The method may also include generating a set of one or more weight values from a corpus of learner text stored in a data storage device. The method may further include calculating, using a processing device, a score for each of the one or more translation candidates in response to the feature associated with each translation candidate and the set of one or more weight values.

In a further embodiment, identifying one or more translation candidates may include selecting a parallel corpus of text from a database of parallel texts, each parallel text comprising text of a first language and corresponding text of a second language, segmenting the text of the first language using the processing device, tokenizing the text of the second language using the processing device, automatically aligning words in the first text with words in the second text using the processing device, extracting phrases from the aligned words in the first text and in the second text using the processing device, and calculating, using the processing device, a probability of a paraphrase match associated with one or more phrases in the first text and one or more phrases in the second text.

In a particular embodiment, the feature associated with each translation candidate is the probability of a paraphrase match. The set of one or more weight values may be calculated using, for example, a minimum error rate training (MERT) operation on a corpus of learner text.

The method may also include generating a phrase table having collocation corrections with features derived from spelling edit distance. In another embodiment, the method may include generating a phrase table having collocation corrections with features derived from a homophone dictionary. In another embodiment, the method may include generating a phrase table having collocation corrections with features derived from synonym dictionary. Additionally, the method may include generating a phrase table having collocation corrections with features derived from native language-induced paraphrases.

In such embodiments, the phrase table comprises one or more penalty features for use in calculating the probability of a paraphrase match.

An apparatus, comprising at least one processor and a memory device coupled to the at least one processor, in which the at least one processor is configured to perform the steps of the method of claims as described above is also presented. A tangible computer readable medium comprising computer readable code that, when executed by a computer, cause the computer to perform the operations as in the method described above is also presented.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed. Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a block diagram illustrating a system for analyzing utterances according to one embodiment of the disclosure.

FIG. 2 is block diagram illustrating a data management system configured to store sentences according to one embodiment of the disclosure.

FIG. 3 is a block diagram illustrating a computer system for analyzing utterances according to one embodiment of the disclosure.

FIG. 4 is a block diagram illustrating a graphical representation for linear-chain CRF.

FIG. 5 is an example tagging of a training sentence for the linear-chain conditional random fields (CRF).

FIG. 6 is block diagram illustrating a graphical representation of a two-layer factorial CRF.

FIG. 7 is an example tagging of a training sentence for the factorial conditional random fields (CRF).

FIG. 8 is a flow chart illustrating one embodiment of a method for inserting punctuation into a sentence.

FIG. 9 is a flow chart illustrating one embodiment of a method for automatic grammatical error correction.

FIG. 10A is a graphical diagram illustrating the accuracy of one embodiment of a text correction model for correcting article errors.

FIG. 10B is a graphical diagram illustrating the accuracy of one embodiment of a text correction model for correcting preposition errors.

FIG. 11A is a graphical diagram illustrating an F₁-measure for the method of correcting article errors as compared to ordinary methods using DeFelice feature set.

FIG. 11B is a graphical diagram illustrating an F₁-measure for the method of correcting article errors as compared to ordinary methods using Han feature set.

FIG. 11C is a graphical diagram illustrating an F₁-measure for the method of correcting article errors as compared to ordinary methods using Lee feature set.

FIG. 12A is a graphical diagram illustrating an F₁-measure for the method of correcting preposition errors as compared to ordinary methods using DeFelice feature set.

FIG. 12B is a graphical diagram illustrating an F₁-measure for the method of correcting preposition errors as compared to ordinary methods using TetreaultChunk feature set

FIG. 12C is a graphical diagram illustrating an F₁-measure for the method of correcting preposition errors as compared to ordinary methods using TetreaultParse feature set.

FIG. 13 is a flow chart illustrating one embodiment of a method for correcting semantic collocation errors.

### DETAILED DESCRIPTION

Various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system. Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

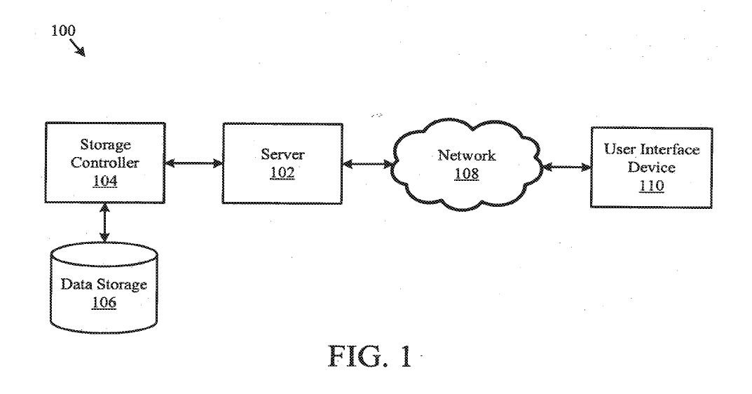

FIG. 1 illustrates one embodiment of a system 100 for automated text and speech editing. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or table computer, a smartphone or other a mobile communication device or organizer device having access to the network 108. In a further embodiment, the user interface device 110 may access the Internet or other wide area or local area network to access a web application or web service hosted by the server 102 and provide a user interface for enabling a user to enter or receive information. For example, the user may enter an input utterance or text into the system 100 through a microphone (not shown) or keyboard 320.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 102 is configured to store input utterances and/or input text. Additionally, the server may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, a tape storage drive comprising a magnetic tape data storage device, an optical storage device, or the like. In one embodiment, the data storage device 106 may store sentences in English or other languages. The data may be arranged in a database and accessible through Structured Query Language (SQL) queries, or other data base query languages or operations.

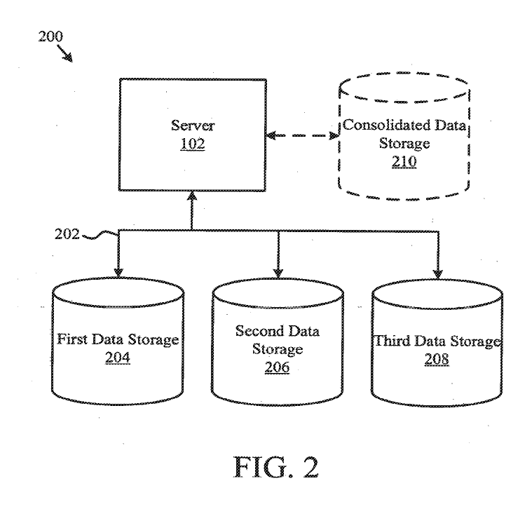

FIG. 2 illustrates one embodiment of a data management system 200 configured to store input utterances and/or input text. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In one embodiment, a corpus of learner text, such as the NUS Corpus of Learner English (NUCLE) may be stored in the first data storage device 204. The second data storage device 206 may store a corpus of, for example, non-learner texts. Examples of non-learner texts may include parallel corpora, news or periodical text, and other commonly available text. In certain embodiments, the non-learner texts are chosen from sources that are assumed to contain relatively few errors. The third data storage device 208 may contain computational data, input texts, and or input utterance data. In a further embodiment, the described data may be stored together in a consolidated data storage device 210.

In one embodiment, the server 102 may submit a query to selected data storage devices 204, 206 to retrieve input sentences. The server 102 may store the consolidated data set in a consolidated data storage device 210. In such an embodiment, the server 102 may refer back to the consolidated data storage device 210 to obtain a set of data elements associated with a specified sentence. Alternatively, the server 102 may query each of the data storage devices 204, 206, 208 independently or in a distributed query to obtain the set of data elements associated with an input sentence. In another alternative embodiment, multiple databases may be stored on a single consolidated data storage device 210.

The data management system 200 may also include files for entering and processing utterances. In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may host a software application configured for analyzing utterances and/or input text. The software application may further include modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

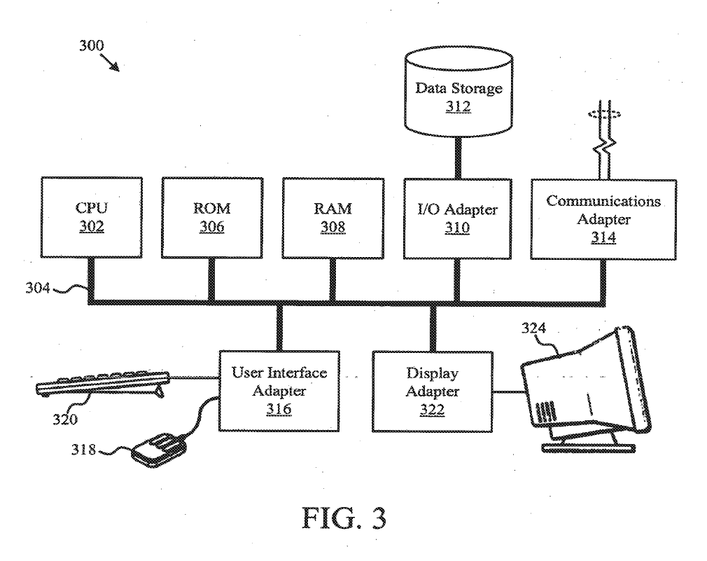

FIG. 3 illustrates a computer system 300 adapted according to certain embodiments of the server 102 and/or the user interface device 110. The central processing unit (“CPU”) 302 is coupled to the system bus 304. The CPU 302 may be a general purpose CPU or microprocessor, graphics processing unit (“GPU”), microcontroller, or the like that is specially programmed to perform methods as described in the following flow chart diagrams. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application having code to analyze utterances. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300 in order to input utterances or text. In a further embodiment, the display adapter 322 may display a graphical user interface associated with a software or web-based application or mobile application for generating sentences with inserted punctuation marks, grammar correction, and other related text and speech editing functions.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

The schematic flow chart diagrams and associated description that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Punctuation Prediction

According to one embodiment, punctuation symbols may be predicted from a standard text processing perspective, where only the speech texts are available, without relying on additional prosodic features such as pitch and pause duration. For example, punctuation prediction task may be performed on transcribed conversational speech texts, or utterances. Different from many other corpora such as broadcast news corpora, a conversational speech corpus may include dialogs where informal and short sentences frequently appear. In addition, due to the nature of conversation, it may also include more question sentences compared to other corpora.

One natural approach to relax the strong dependency assumptions encoded by the hidden event language model is to adopt an undirected graphical model, where arbitrary overlapping features can be exploited. Conditional random fields (CRF) have been widely used in various sequence labeling and segmentation tasks. A CRF may be a discriminative model of the conditional distribution of the complete label sequence given the observation. For example, a first-order linear-chain CRF which assumes first-order Markov property may be defined by the following equation:

$${p}_{λ} ( y \vert x ) = \frac{1}{Z ( x )} exp ( {\sum }_{t} {\sum }_{k} {λ}_{k} {f}_{k} ( x , {y}_{t - 1} , {y}_{t} , t ) ) ,$$

where x is the observation and y is the label sequence. A feature function fₖ as a function of time step t may be defined over the entire observation x and two adjacent hidden labels. Z(x) is a normalization factor to ensure a well-formed probability distribution.

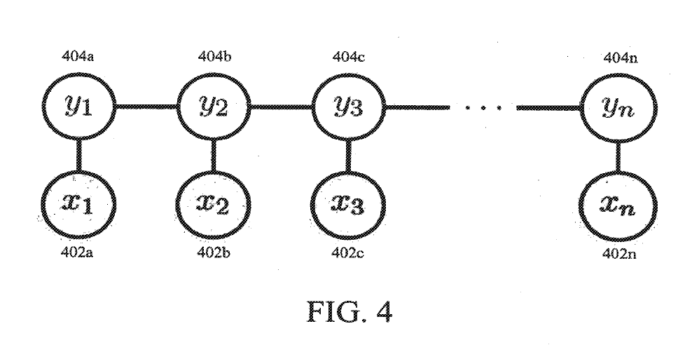

FIG. 4 is a block diagram illustrating a graphical representation for linear-chain CRF. A series of first nodes 402a, 402b, 402c, . . . , 402n are coupled to a series of second nodes 404a, 404b, 404c, . . . , 404n. The second nodes may be events such as word-layer tags associated with the corresponding node of the first nodes 402. Punctuation prediction tasks may be modeled as a process of assigning a tag to each word. A set of possible tags may include none (NONE), comma (,), period (.), question mark (?), and exclamation mark (!). According to one embodiment, each word may be associated with one event. The event identifies which punctuation symbol (possibly NONE) should be inserted after the word.

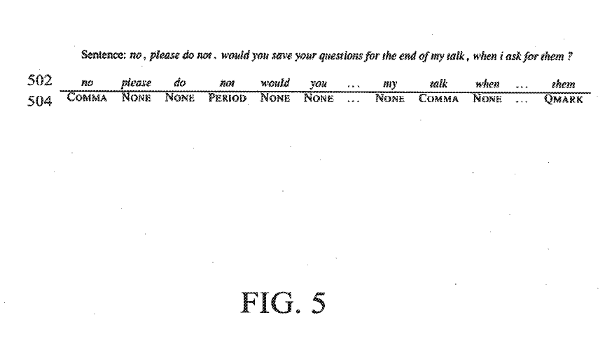

Training data for the model may include a set of utterances where punctuation symbols are encoded as tags that are assigned to the individual words. The tag NONE means no punctuation symbol is inserted after the current word. Any other tag identifies a location for insertion of the corresponding punctuation symbol. The most probable sequence of tags is predicted and the punctuated text can then be constructed from such an output. An example tagging of an utterance may be illustrated in FIG. 5.

FIG. 5 is an example tagging of a training sentence for the linear-chain conditional random fields (CRF). A sentence 502 may be divided into words and a word-layer tag 504 assigned to each of the words. The word-layer tag 504 may indicate a punctuation mark that will follow the word in an output sentence. For example, the word “no” is tagged with “Comma” indicating a comma should follow the word “no.” Additionally, some words such as “please” are tagged with “None” to indicate no punctuation mark should follow the word “please.”

According to one embodiment, a feature of conditional random fields may be factorized as a product of a binary function on assignment of the set of cliques at the current time step (in this case an edge), and a feature function solely defined on the observation sequence. n-gram occurrences surrounding the current word, together with position information, are used as binary feature functions, for n=1; 2; 3. Words that appear within 5 words from the current word are considered when building the features. Special start and end symbols are used beyond the utterance boundaries. For example, for the word do shown in FIG. 5, example features include unigram features “do” at relative position 0, “please” at relative position −1, bigram feature “would you” at relative position 2 to 3, and trigram feature “no please do” at relative position −2 to 0.

A linear-chain CRF model in this embodiment may be capable of modeling dependencies between words and punctuation symbols with arbitrary overlapping features. Thus strong dependency assumptions in the hidden event language model may be avoided. The model may be further improved by including analysis of long range dependencies at a sentence level. For example, in the sample utterance shown in FIG. 5, the long range dependency between the ending question mark and the indicative words “would you” which appear very far away may not be captured.

A factorial-CRF (F-CRF), an instance of dynamic conditional random fields, may be used as a framework for providing the capability of simultaneously labeling multiple layers of tags for a given sequence. The F-CRF learns a joint conditional distribution of the tags given the observation. Dynamic conditional random fields may be defined as the conditional probability of a sequence of label vectors y given the observation x as:

$${p}_{λ} ( y \vert x ) = \frac{1}{Z ( x )} exp ( {\sum }_{t} {\sum }_{c ∈ C} {\sum }_{k} {λ}_{k} {f}_{k} ( x , {y}_{( c , t )} , {y}_{t} , t ) ) ,$$

where cliques are indexed at each time step, C is a set of clique indices, and y_{(c;t)} is the set of variables in the unrolled version of a clique with index c at time t.

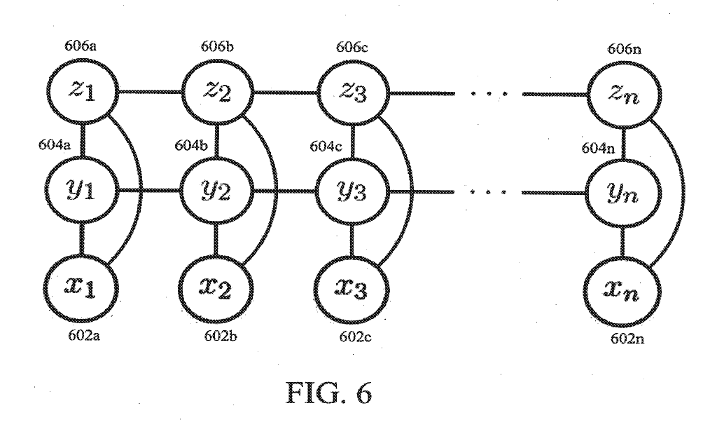

FIG. 6 is block diagram illustrating a graphical representation of a two-layer factorial CRF. According to one embodiment, a F-CRF may have two layers of nodes as tags, where the cliques include the two within-chain edges (e.g., z₂-z₃ and y₂-y₃) and one between-chain edge (e.g., z₃-y₃) at each time step. A series of first nodes 602a, 602b, 602c, . . . , 602n are coupled to a series of second nodes 604a, 604b, 604c, . . . , 604n. A series of third nodes 606a, 606b, 606c, . . . , 606n are coupled to the series of second nodes and the series of first nodes. The nodes of the series of second nodes are coupled with each other to provide long range dependency between nodes.

According to one embodiment, the second nodes are word-layer nodes and the third nodes are sentence-layer nodes. Each sentence-layer node may be coupled with a respective word-layer node. Both sentence-layer nodes and word-layer nodes may be coupled with first nodes. Sentence layer nodes may capture long-range dependencies between word-layer nodes.

In a F-CRF two groups of labels may be assigned to words in an utterance: word-layer tags and sentence-layer tags. Word-layer tags may include none, comma, period, question mark, and/or exclamation mark. Sentence-layer tags may include declaration beginning, declaration inner part, question beginning, question inner part, exclamation beginning, and/or exclamation inner part. The word layer tags may be responsible for inserting a punctuation symbol (including NONE) after each word, while the sentence layer tags may be used for annotating sentence boundaries and identifying the sentence type (declarative, question, or exclamatory).

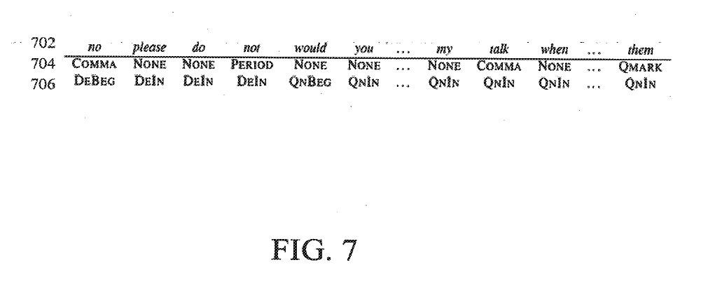

According to one embodiment, tags from the word layer may be the same as those of the linear-chain CRF. The sentence layer tags may be designed for three types of sentences: DEBEG and DEIN indicate the start and the inner part of a declarative sentence respectively, likewise for QNBEG and QNIN (question sentences), as well as EXBEG and EXIN (exclamatory sentences). The same example utterance we looked at in the previous section may be tagged with two layers of tags, as shown in FIG. 7.

FIG. 7 is an example tagging of a training sentence for the factorial conditional random fields (CRF). A sentence 702 may be divided into words and each word tagged with a word-layer tag 704 and a sentence-layer tag 706. For example, the word “no” may be labeled with a comma word-layer tag and a declaration beginning sentence-layer tag.

Analogous feature factorization and the n-gram feature functions used in linear-chain CRF may be used in F-CRF. When learning the sentence layer tags together with the word layer tags, the F-CRF model is capable of leveraging useful clues learned from the sentence layer about sentence type (e.g., a question sentence, annotated with QNBEG, QNIN, QNIN, or a declarative sentence, annotated with DEBEG, DEIN, DEIN), which can be used to guide the prediction of the punctuation symbol at each word, hence improving the performance at the word layer.

For example, consider jointly labeling the utterance shown in FIG. 7. When evidences show that the utterance consists of two sentences—a declarative sentence followed by a question sentence, the model tends to annotate the second half of the utterance with the sentence tag sequence: QNBEG, QNIN. These sentence-layer tags help predict the word-layer tag at the end of the utterance as QMARK, given the dependencies between the two layers existing at each time step. According to one embodiment, during the learning process, the two layers of tags may be jointly learned. Thus the word-layer tags may influence the sentence-layer tags, and vice versa. The GRMM package may be used for building both the linear-chain CRF (LCRF) and factorial CRF (F-CRF). The tree-based reparameterization (TRP) schedule for belief propagation is used for approximate inference.

The techniques described above may allow the use of conditional random fields (CRFs) to perform prediction in utterances without relying on prosodic clues. Thus, the methods described may be useful in post-processing of transcribed conversational utterances. Additionally, long-range dependencies may be established between words in an utterance to improve prediction of punctuation in utterances.

Experiments on part of the corpus of the IWSLT09 evaluation campaign, where both Chinese and English conversational speech texts are used, are carried out with the different methods. Two multilingual datasets are considered, the BTEC (Basic Travel Expression Corpus) dataset and the CT (Challenge Task) dataset. The former consists of tourism-related sentences, and the latter consists of human-mediated cross-lingual dialogs in travel domain. The official IWSLT09 BTEC training set consists of 19,972 Chinese-English utterance pairs, and the CT training set consists of 10,061 such pairs. Each of the two datasets may be randomly split into two portions, where 90% of the utterances are used for training the punctuation prediction models, and the remaining 10% for evaluating the prediction performance. For all the experiments, the default segmentation of Chinese may be used as provided, and English texts may be pre-processed with the Penn Treebank tokenizer. TABLE 1 provides statistics of the two datasets after processing.

The proportions of sentence types in the two datasets are listed. The majority of the sentences are declarative sentences. However, question sentences are more frequent in the BTEC dataset compared to the CT dataset. Exclamatory sentences contribute less than 1% for all datasets and are not listed. Additionally, the utterances from the CT dataset are much longer (with more words per utterance), and therefore more CT utterances actually consist of multiple sentences.

TABLE 1
Statistics of the BTEC and CT Datasets

| | |
|---|---|
| BTEC dataset | CT dataset |

| | Chinese | English | Chinese | English |
|---|---|---|---|---|
| Declarative sentence | 64% | 65% | 77% | 81% |
| Question sentence | 36% | 35% | 22% | 19% |
| Multiple sentences | 14% | 17% | 29% | 39% |
| per utterance | | | | |
| Average number of | 8.59 | 9.46 | 10.18 | 14.33 |
| words per utterance | | | | |

Additional experiments may be divided into two categories: with or without duplicating the ending punctuation symbol to the start of a sentence before training. This setting may be used to assess the impact of the proximity between the punctuation symbol and the indicative words for the prediction task. Under each category, two possible approaches are tested. The single pass approach performs prediction in one single step, where all the punctuation symbols are predicted sequentially from left to right. In the cascaded approach, the training sentences are formatted by replacing all sentence-ending punctuation symbols with special sentence boundary symbols first. A model for sentence boundary prediction may be learned based on such training data. According to one embodiment, this step may be followed by predicting the punctuation symbols.

Both trigram and 5-gram language models are tried for all combinations of the above settings. This provides a total of eight possible combinations based on the hidden event language model. When training all the language models, modified Kneser-Ney smoothing for n-grams may be used. To assess the performance of the punctuation prediction task, computations for precision (prec), recall (rec), and F1-measure (F1), are defined by the following equations:

$$prec . = \frac{\# Correctly predicted punctuation symbols}{\# predicted punctuation symbols}$$

$$rec . = \frac{\# Correctly predicted punctuation symbols}{\# predicted punctuation symbols}$$

$${F}_{1} = \frac{2}{1 / prec . + 1 / rec .}$$

The performance of punctuation prediction on both Chinese (CN) and English (EN) texts in the correctly recognized output of the BTEC and CT datasets are presented in TABLE 2 and TABLE 3, respectively. The performance of the hidden event language model heavily depends on whether the duplication method is used and on the actual language under consideration. Specifically, for English, duplicating the ending punctuation symbol to the start of a sentence before training is shown to be very helpful in improving the overall prediction performance. In contrast, applying the same technique to Chinese hurts the performance.

One explanation may be that an English question sentence usually starts with indicative words such as “do you” or “where” that distinguish it from a declarative sentence. Thus, duplicating the ending punctuation symbol to the start of a sentence so that it is near these indicative words helps to improve the prediction accuracy. However, Chinese presents quite different syntactic structures for question sentences.

First in many cases, Chinese tends to use semantically vague auxiliary words at the end of a sentence to indicate a question. Such auxiliary words include [symbol] and [symbol] . Thus, retaining the position of the ending punctuation symbol before training yields better performance. Another finding is that, different from English, other words that indicate a question sentence in Chinese can appear at almost any position in a Chinese sentence. Examples include [symbol] . . . (where . . . ), . . . [symbol] (what . . . ), or . . . [symbol] . . . (how many/much . . . ). These pose difficulties for the simple hidden event language model, which only encodes simple dependencies over surrounding words by means of n-gram language modeling.

TABLE 2
Punctuation Prediction Performance on Chinese (CN) and English (EN) Texts
in the Correctly Recognized Output of the BTEC Dataset. Percentage Scores of Precision
(Prec.), recall (Rec.), and F1 Measure (F₁) are Reported

| | | BTEC | | | | | | | | | |
|---|---|---|---|---|---|---|---|---|---|---|---|
| | | NO DUPLICATION | | | | USE DUPLICATION | | | | | |
| | | SINGLE PASS | | CASCADED | | SINGLE PASS | | CASCADED | | | |
| LM ORDER | | 3 | 5 | 3 | 5 | 3 | 5 | 3 | 5 | L-CRF | F-CRF |
| CN | Prec. | 87.40 | 86.44 | 87.72 | 87.13 | 76.74 | 77.58 | 77.89 | 78.50 | 94.82 | 94.83 |
| | Rec. | 83.01 | 83.58 | 82.04 | 83.76 | 72.62 | 73.72 | 73.02 | 75.53 | 87.06 | 87.94 |
| | F₁ | 85.15 | 84.99 | 84.79 | 85.41 | 74.63 | 75.60 | 75.37 | 76.99 | 90.78 | 91.25 |
| EN | Prec. | 64.72 | 62.70 | 62.39 | 58.10 | 85.33 | 85.74 | 84.44 | 81.37 | 88.37 | 92.76 |
| | Rec. | 60.76 | 59.49 | 58.57 | 55.28 | 80.42 | 80.98 | 79.43 | 77.52 | 80.28 | 84.73 |
| | F₁ | 62.68 | 61.06 | 60.42 | 56.66 | 82.80 | 83.29 | 81.86 | 79.40 | 84.13 | 88.56 |

TABLE 3
Punctuation Prediction Performance on Chinese (CN) and English (EN) Texts
in the Correctly Recognized Output of the CT Dataset. Percentage Scores of Precision
(Prec.), recall (Rec.), and F1 Measure (F₁) are Reported

| | | CT | | | | | | | | | |
|---|---|---|---|---|---|---|---|---|---|---|---|
| | | NO DUPLICATION | | | | USE DUPLICATION | | | | | |
| | | SINGLE PASS | | CASCADED | | SINGLE PASS | | CASCADED | | | |
| LM ORDER | | 3 | 5 | 3 | 5 | 3 | 5 | 3 | 5 | L-CRF | F-CRF |
| CN | Prec. | 89.14 | 87.83 | 90.97 | 88.04 | 74.63 | 75.42 | 75.37 | 76.87 | 93.14 | 92.77 |
| | Rec. | 84.71 | 84.16 | 77.78 | 84.08 | 70.69 | 70.84 | 64.62 | 73.60 | 83.45 | 86.92 |
| | F₁ | 86.87 | 85.96 | 83.86 | 86.01 | 72.60 | 73.06 | 69.58 | 75.20 | 88.03 | 89.75 |
| EN | Prec. | 73.86 | 73.42 | 67.02 | 65.15 | 75.87 | 77.78 | 74.75 | 74.44 | 83.07 | 86.69 |
| | Rec. | 68.94 | 68.79 | 62.13 | 61.23 | 70.33 | 72.56 | 69.28 | 69.93 | 76.09 | 79.62 |
| | F₁ | 71.31 | 71.03 | 64.48 | 63.13 | 72.99 | 75.08 | 71.91 | 72.12 | 79.43 | 83.01 |

By adopting a discriminative model which exploits non-independent, overlapping features, the LCRF model generally outperforms the hidden event language model. By introducing an additional layer of tags for performing sentence segmentation and sentence type prediction, the F-CRF model further boosts the performance over the L-CRF model. Statistical significance tests are performed with bootstrap resampling. The improvements of F-CRF over L-CRF are statistically significant (p<0.01) on Chinese and English texts in the CT dataset, and on English texts in the BTEC dataset. The improvements of F-CRF over L-CRF on Chinese texts are smaller, probably because L-CRF is already performing quite well on Chinese. F1 measures on the CT dataset are lower than those on BTEC, mainly because the CT dataset consists of longer utterances and fewer question sentences. Overall, the proposed F-CRF model is robust and consistently works well regardless of the language and dataset it is tested on. This indicates that the approach is general and relies on minimal linguistic assumptions, and thus can be readily used on other languages and datasets.

The models may also be evaluated with texts produced by ASR systems. For evaluation, the 1-best ASR outputs of spontaneous speech of the official IWSLT08 BTEC evaluation dataset may be used, which is released as part of the IWSLT09 corpus. The dataset consists of 504 utterances in Chinese, and 498 in English. Unlike the correctly recognized texts described in Section 6.1, the ASR outputs contain substantial recognition errors (recognition accuracy is 86% for Chinese, and 80% for English). In the dataset released by the IWSLT 2009 organizers, the correct punctuation symbols are not annotated in the ASR outputs. To conduct the experimental evaluation, the correct punctuation symbols on the ASR outputs may be manually annotated. The evaluation results for each of the models are shown in TABLE 4. The results show that F-CRF still gives higher performance than L-CRF and the hidden event language model, and the improvements are statistically significant (p<0.01).

TABLE 4
Punctuation Prediction Performance on Chinese (CN) and English (EN) Texts
in the ASR Output of the IWSLT08 BTEC Evaluation Dataset. Percentage Scores of Precision
(Prec.), recall (Rec.), and F1 Measure (F₁) are Reported

| | | BTEC | | | | | | | | | |
|---|---|---|---|---|---|---|---|---|---|---|---|
| | | NO DUPLICATION | | | | USE DUPLICATION | | | | | |
| | | SINGLE PASS | | CASCADED | | SINGLE PASS | | CASCADED | | | |
| LM ORDER | | 3 | 5 | 3 | 5 | 3 | 5 | 3 | 5 | L-CRF | F-CRF |
| CN | Prec. | 85.96 | 84.80 | 86.48 | 85.12 | 66.86 | 68.76 | 68.00 | 68.75 | 92.81 | 93.82 |
| | Rec. | 81.87 | 82.78 | 83.15 | 82.78 | 63.92 | 66.12 | 65.38 | 66.48 | 85.16 | 89.01 |
| | F₁ | 83.86 | 83.78 | 84.78 | 83.94 | 65.36 | 67.41 | 66.67 | 67.60 | 88.83 | 91.35 |
| EN | Prec. | 62.38 | 59.29 | 56.86 | 54.22 | 85.23 | 87.29 | 84.49 | 81.32 | 90.67 | 93.72 |
| | Rec. | 64.17 | 60.99 | 58.76 | 56.71 | 88.22 | 89.65 | 87.58 | 84.55 | 88.22 | 92.68 |
| | F₁ | 63.27 | 60.13 | 57.79 | 55.20 | 86.70 | 88.45 | 86.00 | 82.90 | 89.43 | 93.19 |

In another evaluation of the models, indirect approach may be adopted to automatically evaluate the performance of punctuation prediction on ASR output texts by feeding the punctuated ASR texts to a state-of-the-art machine translation system, and evaluate the resulting translation performance. The translation performance is in turn measured by an automatic evaluation metric which correlates well with human judgments. Moses, a state-of-the-art phrase-based statistical machine translation toolkit is used as a translation engine along with the entire IWSLT09 BTEC training set for training the translation system.

Berkeley aligner is used for aligning the training bitext with the lexicalized reordering model enabled. This is because lexicalized reordering gives better performance than simple distance-based reordering. Specifically, the default lexicalized reordering model (msd-bidirectional-fe) is used. For tuning the parameters of Moses, we use the official IWSLT05 evaluation set where the correct punctuation symbols are present. Evaluations are performed on the ASR outputs of the IWSLT08 BTEC evaluation dataset, with punctuation symbols inserted by each punctuation prediction method. The tuning set and evaluation set include 7 reference translations. Following a common practice in statistical machine translation, we report BLEU-4 scores, which were shown to have good correlation with human judgments, with the closest reference length as the effective reference length. The minimum error rate training (MERT) procedure is used for tuning the model parameters of the translation system.

Due to the unstable nature of MERT, 10 runs are performed for each translation task, with a different random initialization of parameters in each run, and the BLEU-4 scores averaged over 10 runs are reported. The results are shown in Table 5. The best translation performances for both translation directions are achieved by applying F-CRF as the punctuation prediction model to the ASR texts. In addition, we also assess the translation performance when the manually annotated punctuation symbols are used for translation. The averaged BLEU scores for the two translation tasks are 31.58 (Chinese to English) and 24.16 (English to Chinese) respectively, which show that our punctuation prediction method gives competitive performance for spoken language translation.

TABLE 5
Translation Performance on Punctuated ASR Outputs
Using Moses (Averaged Percentage Scores of BLEU)

| | NO DUPLICATION | | | | USE DUPLICATION | | | | | |
|---|---|---|---|---|---|---|---|---|---|---|
| | SINGLE PASS | | CASCADED | | SINGLE PASS | | CASCADED | | | |
| LM Order | 3 | 5 | 3 | 5 | 3 | 5 | 3 | 5 | L-CRF | F-CRF |
| CN→EN | 30.77 | 30.71 | 30.98 | 30.64 | 30.16 | 30.26 | 30.33 | 30.42 | 31.27 | 31.30 |
| EN→CN | 21.21 | 21.00 | 21.16 | 20.76 | 23.03 | 24.04 | 23.61 | 23.34 | 23.44 | 24.18 |

According to the embodiments described above, an exemplary approach for predicting punctuation symbols for transcribed conversational speech texts is described. The proposed approach is built on top of a dynamic conditional random fields (DCRFs) framework, which performs punctuation prediction together with sentence boundary and sentence type prediction on speech utterances. The text processing according to DCRFs may be completed without reliance on prosodic cues. The exemplary embodiments outperform the widely used conventional approach based on the hidden event language model. The disclosed embodiments have been shown to be non-language specific and work well on both Chinese and English, and on both correctly recognized and automatically recognized texts. The disclosed embodiments also result in better translation accuracy when the punctuated automatically recognized texts are used in subsequent translation.

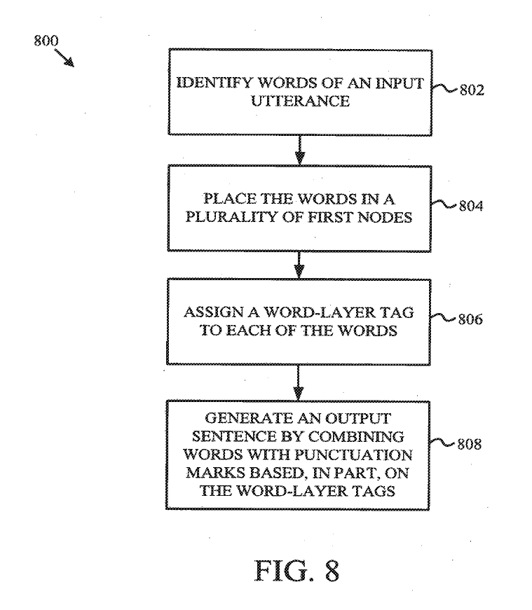

FIG. 8 is a flow chart illustrating one embodiment of a method for inserting punctuation into a sentence. In one embodiment, the method 800 starts at block 802 with identifying words of an input utterance. At block 804 the words are placed in a plurality of first nodes. At block 806 word-layer tags are assigned to each of the first nodes in the plurality of first nodes based, in part, on neighboring nodes of the plurality of first nodes. According to one embodiment, sentence-layer tags may also be assigned to each of the first nodes in the plurality of first nodes. According to another embodiment, sentence-layer tags and/or word-layer tags may be assigned to the first nodes based, in part, on boundaries of the input utterance. At block 808 an output sentence is generated by combining words from the plurality of first nodes with punctuation marks selected, in part, on the word-layer tags assigned to each of the first nodes.

### Grammar Error Correction

There are differences between training on annotated learner text and training on non-learner text, namely whether the observed word can be used as a feature or not. When training on non-learner text, the observed word cannot be used as a feature. The word choice of the writer is “blanked out” from the text and serves as the correct class. A classifier is trained to re-predict the word given the surrounding context. The confusion set of possible classes is usually pre-defined. This selection task formulation is convenient as training examples can be created “for free” from any text that is assumed to be free of grammatical errors. A more realistic correction task is defined as follows: given a particular word and its context, propose an appropriate correction. The proposed correction can be identical to the observed word, i.e., no correction is necessary. The main difference is that the word choice of the writer can be encoded as part of the features.

Article errors are one frequent type of errors made by EFL learners. For article errors, the classes are the three articles a, the, and the zero-article. This covers article insertion, deletion, and substitution errors. During training, each noun phrase (NP) in the training data is one training example. When training on learner text, the correct class is the article provided by the human annotator. When training on non-learner text, the correct class is the observed article. The context is encoded via a set of feature functions. During testing, each NP in the test set is one test example. The correct class is the article provided by the human annotator when testing on learner text or the observed article when testing on non-learner text.

Preposition errors are another frequent type of errors made by EFL learners. The approach to preposition errors is similar to articles but typically focuses on preposition substitution errors. In this work, the classes are 36 frequent English prepositions (about, along, among, around, as, at, beside, besides, between, by, down, during, except, for, from, in, inside, into, of, off, on, onto, outside, over, through, to, toward, towards, under, underneath, until, up, upon, with, within, without). Every prepositional phrase (PP) that is governed by one of the 36 prepositions is one training or test example. PPs governed by other prepositions are ignored in this embodiment.

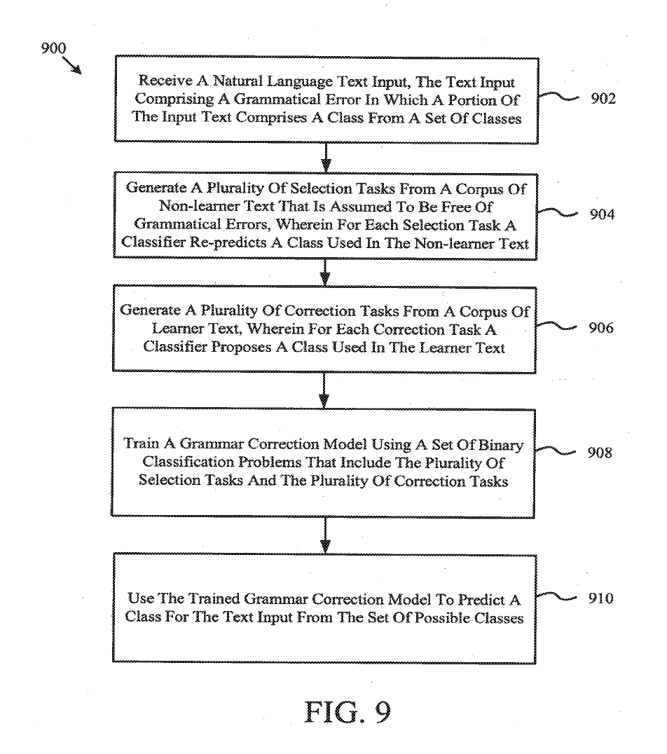

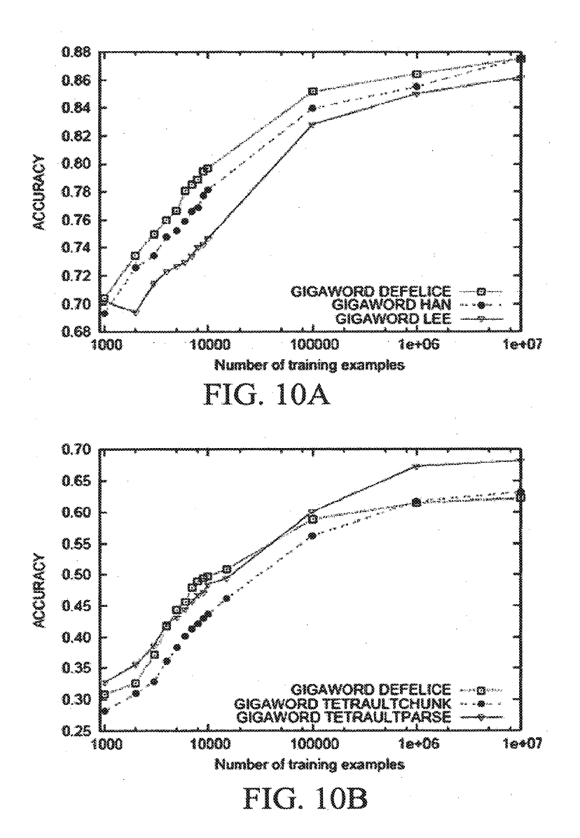

FIG. 9 illustrates one embodiment of a method 900 for correcting grammar errors. In one embodiment, the method 900 may include receiving 902 a natural language text input, the text input comprising a grammatical error in which a portion of the input text comprises a class from a set of classes. This method 900 may also include generating 904 a plurality of selection tasks from a corpus of non-learner text that is assumed to be free of grammatical errors, wherein for each selection task a classifier re-predicts a class used in the non-learner text. Further, the method 900 may include generating 906 a plurality of correction tasks from a corpus of learner text, wherein for each correction task a classifier proposes a class used in the learner text. Additionally, the method 900 may include training 908 a grammar correction model using a set of binary classification problems that include the plurality of selection tasks and the plurality of correction tasks. This embodiment may also include using 910 the trained grammar correction model to predict a class for the text input from the set of possible classes.

According to one embodiment, grammatical error correction (GEC) is formulated as a classification problem and linear classifiers are used to solve the classification problem.

Classifiers are used to approximate the unknown relation between articles or prepositions and their contexts in learner text, and their valid corrections. The articles or prepositions and their contexts are represented as feature vectors Xε [symbol] . The corrections are the classes Yε [symbol] .

In one embodiment, binary linear classifiers of the form u^{T}X, where u is a weight vector, is employed. The outcome is considered +1 if the score is positive and −1 otherwise. A popular method for finding u is empirical risk minimization with least square regularization. Given a training set {Xᵢ, Yᵢ}_{i=1, . . . , n}, the goal is to find the weight vector that minimizes the empirical loss on the training data

$${u}^{⋒} = {arg min}_{u} ( \frac{1}{n} {\sum }_{i = 1}^{n} L ( {u}^{T} {X}_{i} , {Y}_{i} ) + λ {‖ u ‖}^{2} ) ,$$

where L is a loss function. In one embodiment, a modification of Huber's robust loss function is used. The regularization parameter λ may be to 10⁻⁴ according to one embodiment. A multi-class classification problem with m classes can be cast as m binary classification problems in a one-vs-rest arrangement. The prediction of the classifier is the class with the highest score Ŷ=arg max Yε [symbol] (u_{Y}^{T}X).

Six feature extraction methods are implemented, three for articles and three for prepositions. The methods require different linguistic pre-processing: chunking, CCG parsing, and constituency parsing.

Examples of feature extraction for article errors include “DeFelice”, “Han”, and “Lee”. DeFelice—The system for article errors uses a CCG parser to extract a rich set of syntactic and semantic features, including part of speech (POS) tags, hypernyms from WordNet, and named entities. Han—The system relies on shallow syntactic and lexical features derived from a chunker, including the words before, in, and after the NP, the head word, and POS tags. Lee—The system uses a constituency parser. The features include POS tags, surrounding words, the head word, and hypernyms from WordNet.

Examples of feature extraction for preposition errors include “DeFelice”, “TetreaultChunk”, and “TetreaultParse”. DeFelice—The system for preposition errors uses a similar rich set of syntactic and semantic features as the system for article errors. In the re-implementation, a subcategorization dictionary is not used. TetreaultChunk—The system uses a chunker to extract features from a two-word window around the preposition, including lexical and POS ngrams, and the head words from neighboring constituents. TetreaultParse—The system extends TetreaultChunk by adding additional features derived from a constituency and a dependency parse tree.

For each of the above feature sets, the observed article or preposition is added as an additional feature when training on learner text.

According to one embodiment, Alternating Structure Optimization (ASO), a multi-task learning algorithm that takes advantage of the common structure of multiple related problems, can be used for grammatical error correction. Assume that there are m binary classification problems. Each classifier uᵢ is a weight vector of dimension p. Let θ be an orthonormal h×p matrix that captures the common structure of the m weight vectors. It is assumed that each weight vector can be decomposed into two parts: one part that models the particular i-th classification problem and one part that models the common structure

uᵢ=wᵢ+Θ^{T}vᵢ

The parameters [{wᵢ, vᵢ},Θ] can be learned by joint empirical risk minimization, i.e., by minimizing the joint empirical loss of the m problems on the training data

$${\sum }_{l = 1}^{m} ( \frac{1}{n} {\sum }_{i = 1}^{n} L ( {( {w}_{l} + {Θ}^{T} {v}_{l} )}^{T} {X}_{i}^{l} , {Y}_{i}^{l} ) + λ {‖ {w}_{l} ‖}^{2} ) .$$

In ASO, the problems used to find θ do not have to be same as the target problems to be solved. Instead, auxiliary problems can be automatically created for the sole purpose of learning a better θ.

Assuming that there are k target problems and m auxiliary problems, an approximate solution to the above equation can be obtained by performing the following algorithm:
1. Learn m linear classifiers uᵢ independently.
2. Let U=[u₁, u₂ . . . uₘ] be the p×m matrix formed from the m weight vectors.
3. Perform Singular Value Decomposition (SVD) on U: U=V₁DV₂^{T} The first h column vectors of V₁ are stored as rows of θ.
4. Learn wⱼ and vⱼ for each of the target problems by minimizing the empirical risk:

$$\frac{1}{n} {\sum }_{i = 1}^{n} L ( {( {w}_{j} + {Θ}^{T} {v}_{j} )}^{T} {X}_{i} , {Y}_{i} ) + λ {‖ {w}_{j} ‖}^{2} .$$

5. The weight vector for the j-th target problem is:

uⱼ=wⱼ+Θ^{T}vⱼ.

Beneficially, the selection task on non-learner text is a highly informative auxiliary problem for the correction task on learner text. For example, a classifier that can predict the presence or absence of the preposition on can be helpful for correcting wrong uses of on in learner text, e.g., if the classifier's confidence for on is low but the writer used the preposition on, the writer might have made a mistake. As the auxiliary problems can be created automatically, the power of very large corpora of non-learner text can be leveraged.

In one embodiment, a grammatical error correction task with m classes is assumed. For each class, a binary auxiliary problem is defined. The feature space of the auxiliary problems is a restriction of the original feature space χ to all features except the observed word: [symbol] \{X_{obs}}. The weight vectors of the auxiliary problems form the matrix U in Step 2 of the ASO algorithm from which θ is obtained through SVD. Given θ, the vectors wj and vj, j=1, . . . , k can be obtained from the annotated learner text using the complete feature space χ.

This can be seen as an instance of transfer learning, as the auxiliary problems are trained on data from a different domain (nonlearner text) and have a slightly different feature space ( [symbol] \{X_{obs}}). The method is general and can be applied to any classification problem in GEC.

Evaluation metrics are defined for both experiments on non-learner text and learner text. For experiments on non-learner text, accuracy, which is defined as the number of correct predictions divided by the total number of test instances, is used as evaluation metric. For experiments on learner text, F1-measure is used as evaluation metric. The F1-measure is defined as

$${F}_{1} = 2 \times \frac{Precision \times Recall}{Precision + Recall}$$

where precision is the number of suggested corrections that agree with the human annotator divided by the total number of proposed corrections by the system, and recall is the number of suggested corrections that agree with the human annotator divided by the total number of errors annotated by the human annotator.

A set of experiments were designed to test the correction task on NUCLE test data. The second set of experiments investigates the primary goal of this work: to automatically correct grammatical errors in learner text. The test instances were extracted from NUCLE. In contrast to the previous selection task, the observed word choice of the writer can be different from the correct class and the observed word was available during testing. Two different baselines and the ASO method were investigated.

The first baseline was a classifier trained on the Gigaword corpus in the same way as described in the selection task experiment. A simple thresholding strategy was used to make use of the observed word during testing. The system only flags an error if the difference between the classifier's confidence for its first choice and the confidence for the observed word is higher than a threshold t. The threshold parameter t was tuned on the NUCLE development data for each feature set. In the experiments, the value for t was between 0.7 and 1.2.

The second baseline was a classifier trained on NUCLE. The classifier was trained in the same way as the Gigaword model, except that the observed word choice of the writer is included as a feature. The correct class during training is the correction provided by the human annotator. As the observed word is part of the features, this model does not need an extra thresholding step. Indeed, thresholding is harmful in this case. During training, the instances that do not contain an error greatly outnumber the instances that do contain an error. To reduce this imbalance, all instances that contain an error were kept and a random sample of q percent of the instances that do not contain an error was retained. The under-sample parameter q was tuned on the NUCLE development data for each data set. In the experiments, the value for q was between 20% and 40%.

The ASO method was trained in the following way. Binary auxiliary problems for articles or prepositions were created, i.e., there were 3 auxiliary problems for articles and 36 auxiliary problems for prepositions. The classifiers for the auxiliary problems were trained on the complete 10 million instances from Gigaword in the same ways as in the selection task experiment. The weight vectors of the auxiliary problems form the matrix U. Singular value decomposition (SVD) was performed to get U=V₁DV₂^{T}. All columns of V₁ were kept to form θ. The target problems were again binary classification problems for each article or preposition, but this time trained on NUCLE. The observed word choice of the writer was included as a feature for the target problems. The instances that do not contain an error were undersampled and the parameter q was tuned on the NUCLE development data. The value for q is between 20% and 40%. No thresholding is applied.

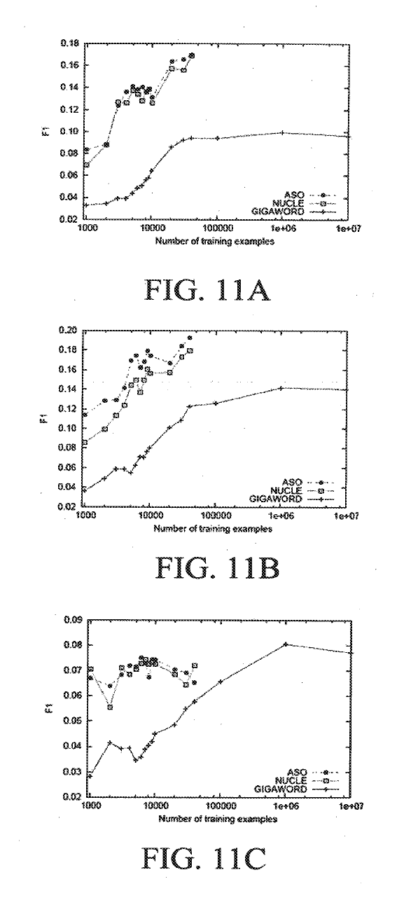

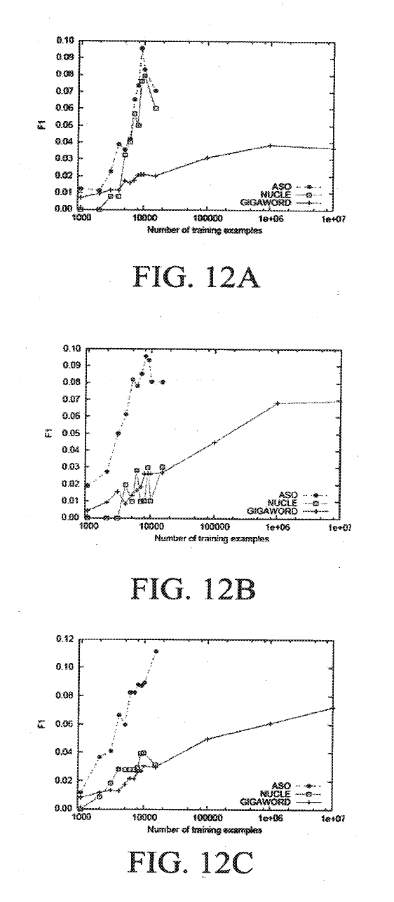

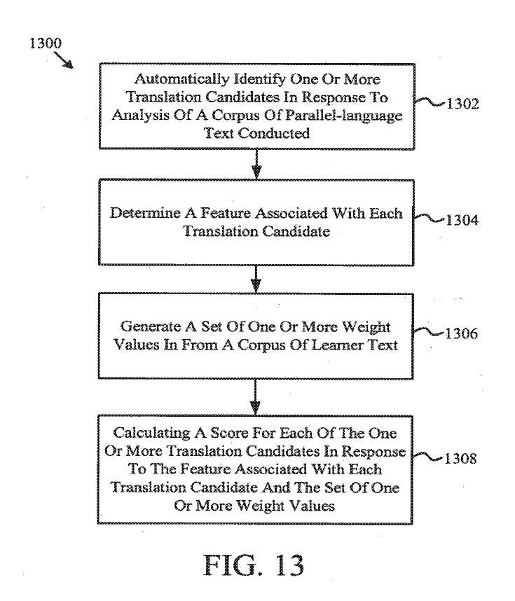

The learning curves of the correction task experiments on NUCLE test data are shown in FIGS. 11 and 12. Each sub-plot shows the curves of three models as described in the last section: ASO trained on NUCLE and Gigaword, the baseline classifier trained on NUCLE, and the baseline classifier trained on Gigaword. For ASO, the x-axis shows the number of target problem training instances. We observe that training on annotated learner text can significantly improve performance In three experiments, the NUCLE model outperforms the Gigaword model trained on 10 million instances. Finally, the ASO models show the best results. In the experiments where the NUCLE models already perform better than the Gigaword baseline, ASO gives comparable or slightly better results. In those experiments where neither baseline shows good performance (TetreaultChunk, TetreaultParse), ASO results in a large improvement over either baseline.

### Semantic Collocation Error Correction

In one embodiment, the frequency of collocation errors caused by the writer's native or first language (L-1). These types of errors are referred to as “L1-transfer errors.” L1-transfer errors are used to estimate how many errors in EFL writing can potentially be corrected with information about the writer's L1-language. For example, L1-transfer errors may be a result of imprecise translations between words in the writers L-1 language and English. In such an example, a word with multiple meanings in Chinese may not precisely translate to a word in, for example, English.

In one embodiment, the analysis is based on the NUS Corpus of Learner English (NUCLE). The corpus consists of about 1,400 essays written by EFL university students on a wide range of topics, like environmental pollution or healthcare. Most of the students are native Chinese speakers. The corpus contains over one million words which are completely annotated with error tags and corrections. The annotation is stored in a stand-off fashion. Each error tag consists of the start and end offset of the annotation, the type of the error, and the appropriate gold correction as deemed by the annotator. The annotators were asked to provide a correction that would result in a grammatical sentence if the selected word or phrase would be replaced by the correction.

In one embodiment, errors which have been marked with the error tag wrong collocation/idiom/preposition are analyzed. All instances which represent simple substitutions of prepositions are automatically filtered out using a fixed list of frequent English prepositions. In a similar way, a small number of article errors which were marked as collocation errors are filtered out. Finally, instances where the annotated phrase or the suggested correction is longer than 3 words are filtered out, as they contain highly context-specific corrections and are unlikely to generalize well (e.g., “for the simple reasons that these can help them”→“simply to”).

After filtering, 2,747 collocation errors and their respective corrections are generated, which account for about 6% of all errors in NUCLE. This makes collocation errors the 7th largest class of errors in the corpus after article errors, redundancies, prepositions, noun number, verb tense, and mechanics. Not counting duplicates, there are 2,412 distinct collocation errors and corrections. Although there are other error types which are more frequent, collocation errors represent a particular challenge as the possible corrections are not restricted to a closed set of choices and they are directly related to semantics rather than syntax. The collocation errors were analyzed and it was found that they can be attributed to the following sources of confusion:

Spelling: An error can be caused by similar orthography if the edit distance between the erroneous phrase and its correction is less than a certain threshold.

Homophones: An error can be caused by similar pronunciation if the erroneous word and its correction have the same pronunciation. A phone dictionary was used to map words to their phonetic representations.

Synonyms: An error can be caused by synonymy if the erroneous word and its correction are synonyms in WordNet. WordNet 3.0 was used.

L1-transfer An error can be caused by L1-transfer if the erroneous phrase and its correction share a common translation in a Chinese-English phrase table. The details of the phrase table construction are described herein. Although the method is used on Chinese-English translation in this particular embodiment, the method is applicable to any language pair where parallel corpora are available.

As the phone dictionary and WordNet are defined for individual words, the matching process is extended to phrases in the following way: two phrases A and B are deemed homophones/synonyms if they have the same length and the i-th word in phrase A is a homophone/synonym of the corresponding i-th word in phrase B.

TABLE 6
Analysis of collocation errors. The threshold for
spelling errors is one for phrase of up to six
characters and two for the remaining phrases.

| Suspected Error Source | Tokens | Types |
|---|---|---|
| Spelling | 154 | 131 |
| Homophones | 2 | 2 |
| Synonyms | 74 | 60 |
| L1-transfer | 1016 | 782 |
| L1-transfer w/o spelling | 954 | 727 |
| L1-transfer w/o homophones | 1015 | 781 |
| L1-transfer w/o synonyms | 958 | 737 |
| L1-transfer w/o spelling, homophones, synonyms | 906 | 692 |

TABLE 7
Examples of collocation errors with different sources of confusion.
The correction is shown in parenthesis. For L1-transfer,
the shared Chinese translation is also shown. The L1-transfer
examples shown here do not belong to any of the other categories.

| | |
|---|---|
| Spelling | it received critics (criticism) as much as complaints |
| | budget for the aged to improvise (improve) other areas |
| Homophones | diverse spending can aide (aid) our country |
| | insure (ensure) the safety of civilians |
| Synonyms | rapid increment (increase) of the seniors |
| | energy that we can apply (use) in the future |
| L1-transfer | and give (provide, [symbol] ) reasonable fares to the public |
| | and concerns (attention, [symbol] ) that the nation put on |
| | technology and engineering |

The results of the analysis are shown in Table 6 Tokens refer to running erroneous phrase-correction pairs including duplicates and types refer to distinct erroneous phrase-correction pairs. As a collocation error can be part of more than one category, the rows in the table do not sum up to the total number of errors. The number of errors that can be traced to L1-transfer greatly outnumbers all other categories. The table also shows the number of collocation errors that can be traced to L1-transfer but not the other sources. 906 collocation errors with 692 distinct collocation error types can be attributed only to L1-transfer but not to spelling, homophones, or synonyms. Table 7 shows some examples of collocation errors for each category from our corpus. There are also collocation error types that cannot be traced to any of the above sources.

A method 1300 for correcting collocation errors in EFL writing is disclosed. One embodiment of such a method 1300 includes automatically identifying 1302 one or more translation candidates in response to analysis of a corpus of parallel-language text conducted in a processing device. Additionally, the method 1300 may include determining 1304, using the processing device, a feature associated with each translation candidate. The method 1300 may also include generating 1306 a set of one or more weight values from a corpus of learner text stored in a data storage device. The method 1300 may further include calculating 1308, using a processing device, a score for each of the one or more translation candidates in response to the feature associated with each translation candidate and the set of one or more weight values.

In one embodiment, the method is based on L1-induced paraphrasing. L1-induced paraphrasing with parallel corpora is used to automatically find collocation candidates from a sentence-aligned L1-English parallel corpus. As most of the essays in the corpus are written by native Chinese speakers, the FBIS Chinese-English corpus is used, which consists of about 230,000 Chinese sentences (8.5 million words) from news articles, each with a single English translation. The English half of the corpus are tokenized and lowercased. The Chinese half of the corpus is segmented using a maximum entropy segmenter. Subsequently, the texts are automatically aligned at the word level using the Berkeley aligner. English-L1 and L1-English phrases of up to three words are extracted from the aligned texts using phrase extraction heuristic. The paraphrase probability of an English phrase e₁ given an English phrase e₂ is defined as

$$p ( {e}_{1} \vert {e}_{2} ) = {\sum }_{f} p ( {e}_{1} \vert f ) p ( f \vert {e}_{2} )$$

where f denotes a foreign phrase in the L1 language. The phrase translation probabilities p(e1|f) and p(f|e₂) are estimated by maximum likelihood estimation and smoothed using Good-Turing smoothing. Finally, only paraphrases with a probability above a certain threshold (set to 0.001 in the work) are kept.

In another embodiment, the method of collocation correction may be implemented in the framework of phrase-based statistical machine translation (SMT). Phrase-based SMT tries to find the highest scoring translation e given an input sentence f. The decoding process of finding the highest scoring translation is guided by a log-linear model which scores translation candidates using a set of feature functions h_{i,}=1, . . . , n

$$score ( e \vert f ) = exp ( {\sum }_{i = 1}^{n} {λ}_{i} {h}_{i} ( e , f ) ) .$$

Typical features include a phrase translation probability p(e|f), an inverse phrase translation probability p(f|e), a language model score p(e), and a constant phrase penalty. The optimization of the feature weights λᵢ, i=1, . . . , n can be done using minimum error rate training (MERT) on a development set of input sentences and the reference translations.

The phrase table of the phrase-based SMT decoder MOSES is modified to include collocation corrections with features derived from spelling, homophones, synonyms, and L1-induced paraphrases.

Spelling: For each English word, the phrase table contains entries consisting of the word itself and each word that is within a certain edit distance from the original word. Each entry has a constant feature of 1.0.

Homophones: For each English word, the phrase table contains entries consisting of the word itself and each of the word's homophones. Homophones are determined using the CuVPlus dictionary. Each entry has a constant feature of 1.0.

Synonyms: For each English word, the phrase table contains entries consisting of the word itself and each of its synonyms in WordNet. If a word has more than one sense, all its senses are considered. Each entry has a constant feature of 1.0.

L1-paraphrases: For each English phrase, the phrase table contains entries consisting of the phrase and each of its L1-derived paraphrases. Each entry has two real-valued features: a paraphrase probability and an inverse paraphrase probability.

Baseline: The phrase tables built for spelling, homophones, and synonyms are combined, where the combined phrase table contains three binary features for spelling, homophones, and synonyms, respectively.

All: The phrase tables from spelling, homophones, synonyms, and L1-paraphrases are combined, where the combined phrase table contains five features: three binary features for spelling, homophones, and synonyms, and two real-valued features for the L1-paraphrase probability and inverse L1-paraphrase probability.

Additionally, each phrase table contains the standard constant phrase penalty feature. The first four tables only contain collocation candidates for individual words. It is left to the decoder to construct corrections for longer phrases during the decoding process if necessary.

A set of experiments was carried out to test the methods of semantic collocation error correction. The data set used for the experiments was a randomly sampled development set of 770 sentences and a test set of 856 sentences from the corpus. Each sentence contained exactly one collocation error. The sampling was performed in a way that sentences from the same document cannot end up in both the development and the test set. In order to keep conditions as realistic as possible, the test set was not filtered in any way.

Evaluation metrics were also defined for the experiments to evaluation the collocation error correction. An automatic and a human evaluation were conducted. The main evaluation metric is mean reciprocal rank (MRR) which is the arithmetic mean of the inverse ranks of the first correct answer returned by the system

$$M R R = \frac{1}{N} {\sum }_{i = 1}^{N} \frac{1}{rank ( i )}$$

where N is the size of the test set. If the system did not return a correct answer for a test instance,

$$\frac{1}{rank ( i )}$$

is set to zero.

In the human evaluation, precision at rank k, k=1, 2, 3, was additionally reported, where the precision is calculated as follows:

$$P @ k = \frac{{\sum }_{a ∈ A} score ( a )}{\vert A \vert}$$

where A is the set of returned answers of rank k or less and score(•) is a real-valued scoring function between zero and one.

In the collocation error experiments, automatic correction of collocation errors can conceptually be divided into two steps: i) identification of wrong collocations in the input, and ii) correction of the identified collocations. It was assumed that the erroneous collocation had already been identified.

In the experiments, the start and end offset of the collocation error provided by the human annotator was used to identify the location of the collocation error. The translation of the rest of the sentence was fixed to its identity. Phrase table entries where the phrase and the candidate correction are identical were removed, which practically forced the system to change the identified phrase. The distortion limit of the decoder was set to zero to achieve monotone decoding. For the language model, a 5-gram language model trained on the English Gigaword corpus with modified Kneser-Ney smoothing was used. All experiments used the same language model to allow a fair comparison.

MERT training with the popular BLEU metric was performed on the development set of erroneous sentences and their corrections. As the search space was restricted to changing a single phrase per sentence, training converges relatively quickly after two or three iterations. After convergence, the model can be used to automatically correct new collocation errors.

The performance of the proposed method was evaluated on the test set of 856 sentences, each with one collocation error. Both an automatic and a human evaluation were conducted. In the automatic evaluation, the system's performance was measured by computing the rank of the gold answer provided by the human annotator in the n-best list of the system. The size of the n-best list was limited to the top 100 outputs. If the gold answer was not found in the top 100 outputs, the rank was considered to be infinity, or in other words, the inverse of the rank is zero. The number of test instances for which the gold answer was ranked among the top k answers, k=1, 2, 3, 10, 100 was reported. The results of the automatic evaluation are shown in Table 8.

TABLE 8
Results of automatic evaluation. Columns two to six show the number of
gold answers that are ranked within the top k answers. The last column
shows the mean reciprocal rank in percentage. Bigger values are better.

| Model | Rank = 1 | Rank ≦ 2 | Rank ≦ 3 | Rank ≦ 10 | Rank ≦ 100 | MRR |
|---|---|---|---|---|---|---|
| Spelling | 35 | 41 | 42 | 44 | 44 | 4.51 |
| Homophones | 1 | 1 | 1 | 1 | 1 | 0.11 |
| Synonyms | 32 | 47 | 52 | 60 | 61 | 4.98 |
| Baseline | 49 | 68 | 80 | 93 | 96 | 7.61 |
| L1-paraphrases | 93 | 133 | 154 | 216 | 243 | 15.43 |
| All | 112 | 150 | 166 | 216 | 241 | 17.21 |

TABLE 9
Inter-annotator agreement P(E) = 0.5

| | |
|---|---|
| P(A) | 0.8076 |
| Kappa | 0.6152 |

For collocation errors, there is usually more than one possible correct answer. Therefore, automatic evaluation underestimates the actual performance of the system by only considering the single gold answer as correct and all other answers as wrong. A human evaluation for the systems BASELINE and ALL was carried out. Two English speakers were recruited to judge a subset of 500 test sentences. For each sentence, a judge was shown the original sentence and the 3-best candidates of each of the two systems. The human evaluation was restricted to the 3-best candidates, as the answers at a rank larger than three will not be very useful in a practical application. The candidates were displayed together in alphabetical order without any information about their rank or which system produced them or the gold answer by the annotator. The difference between the candidates and the original sentence was highlighted. The judges were asked to make a binary judgment for each of the candidates on whether the proposed candidate was a valid correction of the original or not. Valid corrections were represented with a score of 1.0 and invalid corrections with a score of 0.0. Inter-annotator agreement was reported in Table 8 The chance of agreement P(A) is the percentage of times that the annotators agree, and P(E) is the expected agreement by chance, which is 0.5 in our case. The Kappa coefficient is defined as

$$Kappa = \frac{P ( A ) - P ( E )}{1 - P ( E )}$$

A Kappa coefficient of 0.6152 was obtained from the experiment, where a Kappa coefficient between 0.6 and 0.8 is considered as showing substantial agreement. To compute precision at rank k, the judgments was averaged. Thus, a system can receive a score of 0.0 (both judgments negative), 0.5 (judges disagree), or 1.0 (both judgments positive) for each returned answer.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. An apparatus, comprising:
at least one processor and a memory device coupled to the at least one processor, in which the at least one processor is configured:
to receive a natural language text input, the text input comprising a grammatical error in which a portion of the input text comprises a class from a set of classes;
to generate a plurality of selection tasks from a corpus of non-learner text that is assumed to be free of grammatical errors, wherein for each selection task a classifier re-predicts a class used in the non-learner text;
to generate a plurality of correction tasks from a corpus of learner text, wherein for each correction task a classifier proposes a class used in the learner text;
to train a grammar correction model using a set of binary classification problems that include the plurality of selection tasks and the plurality of correction tasks; and
to use the trained grammar correction model to predict a class for the text input from the set of possible classes.

2. The apparatus of claim 1, in which the at least one processor is further configured to outputting a suggestion to change the class of the text input to the predicted class if the predicted class is different than the class in the text input.

3. The apparatus of claim 1, wherein the learner text is annotated by a teacher with an assumed correct class.

4. The apparatus of claim 1, wherein the class is a preposition associated with a prepositional phrase in the input text, and wherein the at least one processor is further configured to extract feature functions for the classifiers from prepositional phrases in the non-learner text and the learner text.

5. The apparatus of claim 1, wherein the class is a preposition associated with a prepositional phrase in the input text, and wherein the at least one processor is further configured to extract feature functions for the classifiers from prepositional phrases in the non-learner text and the learner text.

6. The apparatus of claim 1, wherein the non-learner text and the learner text have a different feature space, the feature space of the learner text including the word used by a writer.

7. The apparatus of claim 1, wherein training the grammar correction model comprises minimizing a loss function on the training data.

8. The apparatus of claim 1, wherein training the grammar correction model further comprises identifying a plurality of linear classifiers through analysis of the non-learner text, and wherein the linear classifiers further comprise a weight factor included in a matrix of weight factors, and wherein training the grammar correction model further comprises performing a Singular Value Decomposition (SVD) on the matrix of weight factors.

9. A non-transitory tangible computer-readable medium comprising computer-readable code that, when executed by a computer, cause the computer:
to receive a natural language text input, the text input comprising a grammatical error in which a portion of the input text comprises a class from a set of classes;
to generate a plurality of selection tasks from a corpus of non-learner text that is assumed to be free of grammatical errors, wherein for each selection task a classifier re-predicts a class used in the non-learner text;
to generate a plurality of correction tasks from a corpus of learner text, wherein for each correction task a classifier proposes a class used in the learner text;
to train a grammar correction model using a set of binary classification problems that include the plurality of selection tasks and the plurality of correction tasks; and
to use the trained grammar correction model to predict a class for the text input from the set of possible classes.

10. The non-transitory tangible computer-readable medium of claim 9, wherein the computer-readable code further comprises computer-readable code that cause the computer to output a suggestion to change the class of the text input to the predicted class if the predicted class is different than the class in the text input.

11. The non-transitory tangible computer-readable medium of claim 9, wherein the learner text is annotated by a teacher with an assumed correct class.

12. The non-transitory tangible computer-readable medium of claim 9, wherein the class is an article associated with a noun phrase in the input text, and wherein the computer-readable code further comprises computer-readable code that cause the computer to extract feature functions for the classifiers from noun phrases in the non-learner text and the learner text.

13. The non-transitory tangible computer-readable medium of claim 9, wherein the class is a preposition associated with a prepositional phrase in the input text, and wherein the computer-readable code further comprises computer-readable code that cause the computer to extract feature functions for the classifiers from prepositional phrases in the non-learner text and the learner text.

14. The non-transitory tangible computer-readable medium of claim 9, wherein the non-learner text and the learner text have a different feature space, the feature space of the learner text including the word used by a writer.

15. The non-transitory tangible computer-readable medium of claim 9, wherein training the grammar correction model comprises minimizing a loss function on the training data.

16. The non-transitory tangible computer-readable medium of claim 9, wherein training the grammar correction model further comprises identifying a plurality of linear classifiers through analysis of the non-learner text, and wherein the linear classifiers further comprise a weight factor included in a matrix of weight factors, and wherein training the grammar correction model further comprises performing a Singular Value Decomposition (SVD) on the matrix of weight factors.
